(19) United States
(12) Patent Application Publication
(10) Pub. No.: US 2013/0036275 A1
(43) Pub. Date: Feb. 7, 2013

(54) CIRCUIT AND METHOD FOR RAPIDLY TRANSMITTING DATA

(71) Applicant: KANG-BIN WANG, Shenzhen City (CN)

(72) Inventor: KANG-BIN WANG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/527,663

(22) Filed: Jun. 20, 2012

(30) Foreign Application Priority Data
Aug. 2, 2011 (CN) 201110219809.X

(51) Int. Cl. G06F 12/00

(52) U.S. Cl. 711/154; 711/E12.001

(57) ABSTRACT

A circuit for the rapid transmission of data is presented. The circuit includes a control unit, a data storage unit, and a data processing unit. The data processing unit includes an interrupt module, a processor chipset, an access controller, a first register and a second register. The interrupt module is connected to the control unit and receives an interrupt signal from the control unit. The access controller reads data from the data storage unit according to a beginning address and an ending address included in the interrupt signal and stores the retrieved data alternately in the first register and in the second register. The processor chipset retrieves and displays data from the second register when data is in the first register and retrieves and displays data from the first register when data is in the second register.

### BACKGROUND

1. Technical Field

The disclosure generally relates to electronic circuits, and particularly relates to a circuit and a method for rapidly transmitting data.

2. Description of Related Art

Multimedia products, such as multimedia televisions and personal multimedia players (PMPs), store and play digital media such as audio, images, video and documents. Features such as high resolution, high fidelity, and high quality have made multimedia products more common, and such features also require the multimedia products to be equipped with high-performance hardware components. For example, the digital media may be stored in a hard drive disk, a compact disc, or a flash memory. A main processor of a multimedia product has to retrieve media data from a storage unit and process the retrieved media data, such as decompressing and decoding the retrieved media data in parallel. Such multiple demands of the main processor may throttle an overall performance of the multimedia product if the main processor is not fast enough. One solution is to constantly upgrade the main processer to meet the ever-growing demands. However, the constant renewal of high-end processors will increase cost.

Therefore, there is a need to provide a circuit and a method for rapidly transmitting data.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a functional block diagram of a circuit for rapidly transmitting data according to one embodiment.

FIGS. 2A and 2B show a flowchart showing one embodiment of a method for rapidly transmitting data using the circuit of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media comprise CDs, DVDs, BLU-RAY, flash memory, and hard disk drives.

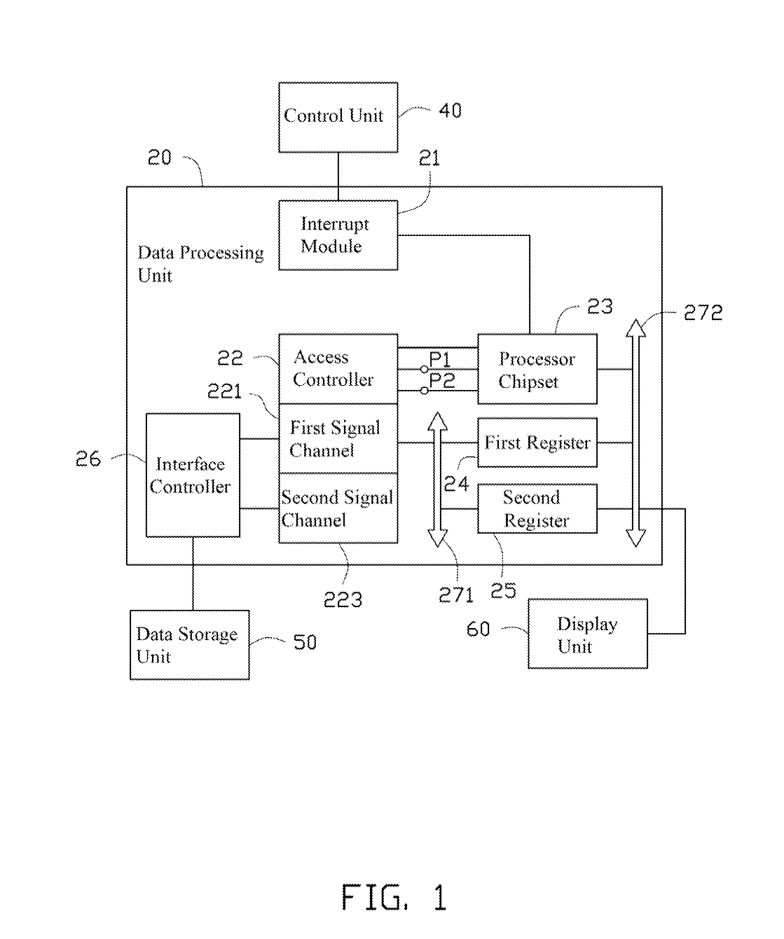

FIG. 1 shows a circuit for the rapid transmission of data according to one embodiment. The circuit includes a data processing unit 20, a control unit 40, a data storage unit 50 and a display unit 60. The data processing unit 20 is connected to the control unit 40, to the data storage unit 50, and to the display unit 60.

The data processing unit 20 includes an interrupt module 21, an access controller 22, a processor chipset 23, a first register 24, a second register 25, and an interface controller 26.

The interface controller 26 interconnects the access controller 22 and the data storage unit 50. The data storage unit 50 stores data. The data processing unit 20 may read data from the data storage unit 50 via the interface controller 26.

The interrupt module 21 is connected to the control unit 40. The interrupt module 21 may receive an interrupt signal from the control unit 40. For example, when the control unit 40 instructs the data processing unit 20 to read data from the data storage unit 50, the control unit 40 may send an interrupt signal to the interrupt module 21. The interrupt signal includes a beginning address and an ending address to indicate the location of the desired data in the data storage unit 50. Then the data processing unit 20 may read the desired data from the data storage unit 50 in response to the interrupt signal.

The processor chipset 23 is connected to the interrupt module 21 and also connected to the access controller 22. When the processor chipset 23 receives the interrupt signal from the interrupt module 21, the processor chipset 23 may initiate the access controller 22 and send the beginning address and the ending address included in the interrupt signal to the access controller 22.

The access controller 22 includes a first signal channel 221 and a second signal channel 223. The first signal channel 221 and the second signal channel 223 are connected to the interface controller 26. The first signal channel 221 is connected to the first register 24 and to the second register 25 via a first bus 271. The access controller 22 may send the beginning address and the ending address to the interface controller 26 via the second signal channel 223. The interface controller 26 may read data from the data storage unit 50 according to the beginning address and the ending address and transmit the data to the first register 24 and the second register 25 via the first signal channel 221. The access controller 22 includes a first chip selection pin P1 and a second chip selection pin P2. The first chip selection pin P1 and the second chip selection pin P2 are connected to the processor chipset 23. When the first chip selection pin P1 is at a low level, the access controller 22 will select the first register 24 and store data in the first register 24. When the second chip selection pin P2 is at a low level, the access controller 22 will select the second register 25 and store data in the second register 25.

The first register 24 and the second register 25 are connected to the display unit 60 via a second bus 272. The first register 24 and the second register 25 are connected to the processor chipset 23 via the second bus 272. The processor chipset 23 may read data from the first register 24 and from the second register 25 and transmit the data to the display unit 60. The display unit 60 may display the data received from the processor chipset 23.

The following describes in detail how the access controller 22 and the processor chipset 23 work. At the beginning, the access controller 22 sets the first chip selection pin P1 at a low level and sets the second chip selection pin P2 at a high level. The interface controller 26 stores the data read from the data storage unit 50 to the first register 24. When the storage space of the first register 24 is used up, the access controller 22 sets the first chip selection pin P1 at a high level and sets the second chip selection pin P2 at a low level. Then the interface controller 26 will store the data read from the data storage unit 50 to the second register 25. In the meantime, once the processor chipset 23 detects that the first chip selection pin P1 is at a high level, the processor chipset 23 retrieves data from the first register 24 and transmits the data to the display unit 60. When the storage space of the second register 25 is used up, the access controller 22 sets the first chip selection pin P1 at a low level and sets the second chip selection pin P2 at a high level again. Then the interface controller 26 clears the first register 24 and stores the data read from the data storage unit 50 to the first register 24. In the meantime, once the processor chipset 23 detects that the second chip selection pin P2 is at a high level, the processor chipset 23 retrieves data from the second register 25 and transmits the data to the display unit 60. The process will be performed reiteratively until the interface controller 26 has read all the desired data from the data storage unit 50. Thus the access controller 22 stores data alternately in the first register 24 and then in the second register 25 and the processor chipset 23 alternately retrieves the data from the second register 25 and then from the first register 24. The storing process by the access controller 22 and the retrieving process by the processor chipset 23 are performed in parallel thereby increasing the overall throughput of a data processing system.

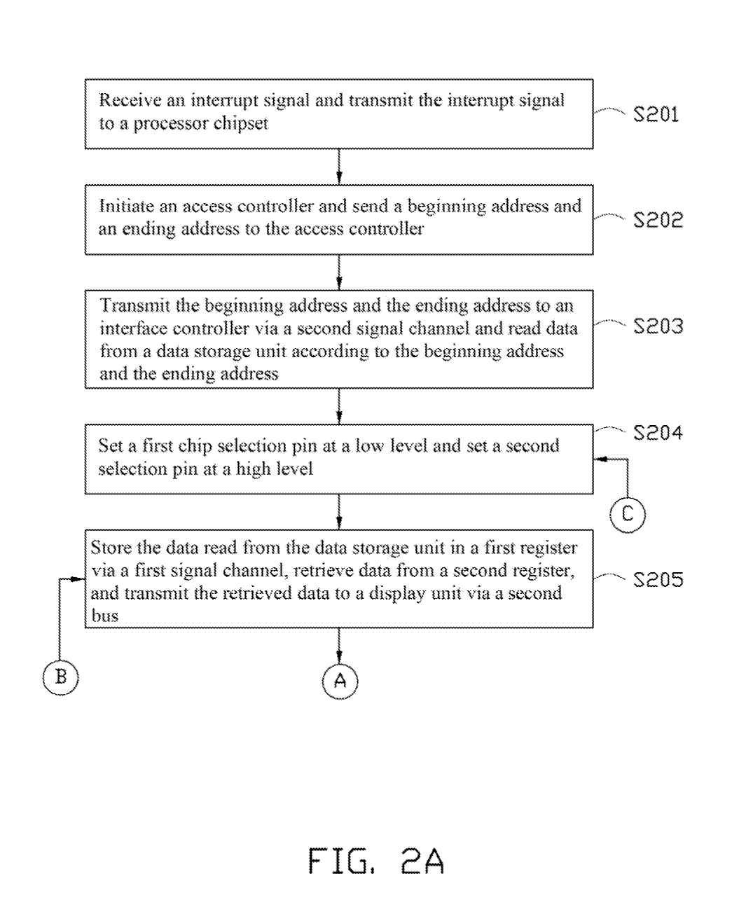

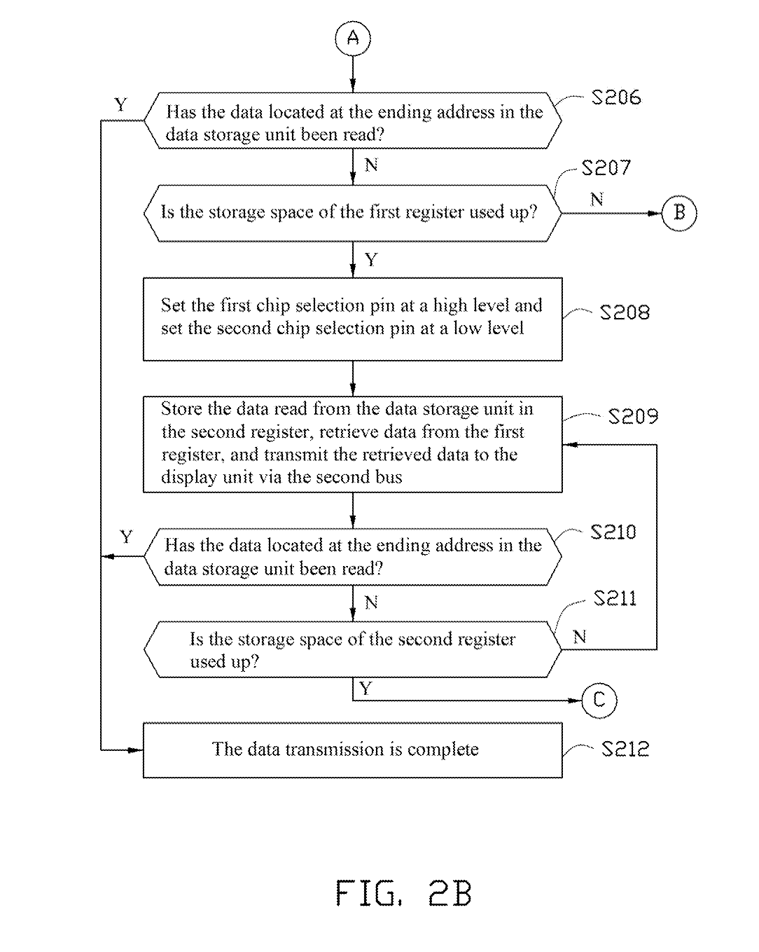

FIGS. 2A and 2B illustrates a flowchart showing one embodiment of a method for rapidly transmitting data using the circuit of FIG. 1. The method comprises the following steps.

In step S201, the interrupt module 21 receives an interrupt signal from the control unit 40 and transmits the interrupt signal to the processor chipset 23.

In step S202, the processor chipset 23 initiates the access controller 22 and sends a beginning address and an ending address included in the interrupt signal to the access controller 22.

In step S203, the access controller 22 transmits the beginning address and the ending address to the interface controller 26 via the second signal channel 223. The interface controller 26 read data from the data storage unit 50 according to the beginning address and the ending address.

In step S204, the access controller 22 sets the first chip selection pin P1 at a low level and sets the second selection pin P2 at a high level.

In step S205, the interface controller 26 stores the data read from the data storage unit 50 in the first register 24 via the first signal channel 221. The processor chipset 23 retrieves data from the second register 25 and transmits the retrieved data to the display unit 60 via the second bus 272.

In step S206, the interface controller 26 determines whether the data located between the beginning address and the ending address in the data storage unit 50 has been read. If so, the flow goes to step S212. If not, the flow goes to step S207.

In step S207, the access controller 22 determines whether the storage space of the first register 24 is used up. If so, the flow goes to step S208. If not, the flow goes to step S205.

In step S208, the access controller 22 sets the first chip selection pin P1 at a high level and sets the second chip selection pin P2 at a low level.

In step S209, the interface controller 26 stores the data read from the data storage unit 50 in the second register 25. The processor chipset 23 retrieves the data from the first register 24 and transmits the retrieved data to the display unit 60 via the second bus 272.

In step S210, the interface controller 26 determines whether the data located between the beginning address and the ending address in the data storage unit 50 has been read. If so, the flow goes to step S212. If not, the flow goes to step S211.

In step S211, the access controller 22 determines whether the storage space of the second register 25 is used up. If so, the flow goes to step S204. If not, the flow goes to step S209.

In step S212, the transmission of all data is complete.

Although numerous characteristics and advantages have been set forth in the foregoing description of embodiments, together with details of the structures and functions of the embodiments, the disclosure is illustrative only and changes may be made in detail, especially in the matters of shape, size, and arrangement of parts within the principles of the disclosure to the full extent indicated by the broad general meaning of the terms in which the appended claims are expressed.

Depending on the embodiment, certain steps or methods described may be removed, others may be added, and the sequence of steps may be altered. The description and the claims drawn for or in relation to a method may give some indication in reference to certain steps. However, any indication given is only to be viewed for identification purposes and not as a suggestion as to an order for the steps.

What is claimed is:

1. A circuit for transmitting data, the circuit comprising:
a control unit;
a data storage unit; and
a data processing unit comprising an interrupt module, a processor chipset, an access controller, a first register and a second register;
wherein the interrupt module is connected to the control unit and is adapted to receive an interrupt signal from the control unit, the access controller is adapted to read data from the data storage unit according to a beginning address and an ending address in the interrupt signal and store the data in the first register and the second register alternately, the processor chipset is adapted to retrieve data from the second register when data is being stored in the first register and to retrieve data from the first register when data is being stored in the second register.

2. The circuit of claim 1, wherein the access controller comprises a first chip selection pin and a second chip selection pin, the access controller is adapted to store the data in the first register when the first chip selection pin is at a low level and the second chip selection pin is at a high level, and to store the data in the second register when the first chip selection pin is at a high level and the second chip selection pin is at a low level.

3. The circuit of claim 2, wherein the processor chipset is adapted to retrieve data from the first register when the first chip selection pin is at a high level, and to retrieve data from the second register when the second chip selection pin is at a high level.

4. The circuit of claim 1, wherein the data processing unit further comprises an interface controller interconnecting the access controller and the data storage unit.

5. The circuit of claim 4, wherein the access controller further comprises a first signal channel, the access controller is adapted to store the data in the first register and the second register via the first signal channel.

6. The circuit of claim 5, wherein the access controller further comprises a second signal channel, the access controller is adapted to send the beginning address and the ending address to the interface controller via the second signal channel, the interface controller is adapted to read data from the data storage unit according to the beginning address and the ending address and to transmit the data to the access controller.

7. The circuit of claim 1, further comprising a display unit, the data processing unit is adapted to transmit the data retrieved from the first register and the second register to the display unit, the display unit is adapted to display the data received from the data processing unit.

8. A method for transmitting data, the method comprising:
receiving an interrupt signal from a control unit and transferring the interrupt signal to a processor chipset by an interrupt module;
initiating an access controller and sending a beginning address and an ending address in the interrupt signal to the access controller by the processor chipset;
reading data from a data storage unit by the access controller according to the beginning address and the ending address;
storing the data in a first register and a second register alternately by the access controller; and
retrieving data from the second register by the processor chipset when data is being stored in the first register and retrieving data from the first register by the processor chipset when data is being stored in the second register.

9. The method of claim 8, wherein the storing comprises storing the data in the first register when a first chip selection pin of the access controller is at a low level and a second chip selection pin of the access controller is at a high level, and storing the data in the second register when the first chip selection pin is at a high level and the second chip selection pin is at a low level.

10. The method of claim 9, wherein the retrieving comprises retrieving data from the first register by the processor chipset when the first chip selection pin is at a high level, and retrieving data from the second register when the second chip selection pin is at a high level.

11. The method of claim 8, wherein the storing of the data by the access controller into the first register and the second register is through a first signal channel of the access controller.

12. The method of claim 11, wherein the reading of the data comprises:
sending the beginning address and the ending address to an interface controller by the access controller via a second signal channel of the access controller;
reading data from the data storage unit according to the beginning address and the ending address by the interface controller; and
transmitting the data to the access controller by the interface controller.

13. The method of claim 8, further comprising:
transmitting the data retrieved from the first register and the second register to a display unit by the processor chipset; and
displaying the data received from the processor chipset by the display unit.
